(19) United States
(12) Patent Application Publication
(10) Pub. No.: US 2003/0236693 A1
(43) Pub. Date: Dec. 25, 2003

(54) Method of implementing a collaborative business process

(76) Inventors: Qiming Chen, Sunnyvale, CA (US); Umeshwar Dayal, Saratoga, CA (US); Meichun Hsu, Los AltosHills, CA (US)

Correspondence Address: HEWLETT-PACKARD COMPANY, Intellectual Property Administration, P.O. Box 272400, Fort Collins, CO, 80527-2400, US

(21) Appl. No.: 10/175,660

(22) Filed: Jun. 19, 2002

(51) Int. Cl. G06F 17/60

(52) U.S. Cl. 705/9

(57) ABSTRACT

A method of implementing a collaborative business process. A collaborative business process is designed to be executed by two or more players. The collaborative business process has a number of tasks. A number of roles are assigned to the collaborative business process and at least one of the roles is assigned to the tasks. The players instantiate a copy of the collaborative business process at their nodes and take a role in the collaborative business process. Therefore, the tasks are assigned to at least one player. Finally, the tasks are executed in synchronized fashion at the nodes for the players.

### TECHNICAL FIELD

The present invention relates to the field of business processes. In particular, the present invention relates to implementing a collaborative business process to be executed by a number of players.

### BACKGROUND ART

As the Internet evolves from providing information access into a platform for e-business, there is a need for modeling and automating inter-business interactions. Today, business-to-business interaction based on Extensible Markup Language (XML) document exchange has been discussed. However, there is only limited technology for defining and automating these interactions at the business process level.

FIG. 1 shows the layers of a technology stack 120 to support these protocols, and conventional protocols 130 available today for the different layers. The lower layer of the technology stack 120 is a vocabulary layer 121, which provides for an agreement of a basic vocabulary that is needed when using a computer based technology. The vocabulary layer 121 may be defined as the definitions for terms that are used in a transaction, for example in a business interaction. This library provides definitions for terms such as, company, service, procurement, good, etc. Exemplary standards providing such vocabularies are the Common Business Library (CBL) and RosettaNet.

At the next level of the technology stack 120 is the business object document 122. This level 122 may cover business forms or documents, examples of which may be: a request for quote, a purchase order, an invoice, etc. Today there exist many definitions of these structures, which may be XML documents.

At the next level up the technology stack 120 is the conversation business rule layer 123. These business rules define the action a party is to take upon a condition occurring. For example, if party B receives a certain document, party B will first check that the document is in the right format, then party B will take a specified action. For example, if party B receives a bid, party B checks to see if it meets party B's requirements. If so, party B will send back a contract. However, no uniform set of conversation business rules exist at this time.

Finally, at the top level of the technology stack 120 is the business process layer 124. A business process may be defined as a sequence of events that are to occur, along with various conditions. For example, referring to FIG. 2A, a business process may have a number of task nodes 140, which define a task to perform, and route nodes 141, which define conditions and allow branches to be taken.

To deal with the complexities of inter-enterprise e-business, common agreement at multiple layers of the technology stack 120 may be needed. Unfortunately, most of the above methods operate at a single layer, or at most two layers. None of the methods operates at all four layers of the technology stack 120.

For example, distributed computing architectures such as CORBA (Common Object Broker Request Architecture), e-speak, and Jini may cover only the vocabulary layer 121. Referring again to FIG. 1, consortial efforts such as the Common Business Library 130f (CBL) from CommerceNet may cover the business object layer 122 in addition to the vocabulary layer. However, such efforts may fail to cover higher layers of the technology stack 120. Several protocols, which address task-level interactions, may address only the conversation business rule layer 123, for example Biz Talk, SOAP (Simple Object Access Protocol), and the RosettaNet PIPs (Partner Interface Process) (collectively 130c). Handling inter-business interaction at the conversation business rule layer 123 based on individual rules specifying a single-round document exchange may provide flexibility but may not be suitable for transactional e-business applications involving complex, concurrent, long-duration, long-waiting and nested tasks. Consequently, methods such as RosettaNet, BizTalk, and SOAP may be limited in this respect.

Still referring to FIG. 1, other protocols such as, ebXML (Electronic Business Extensible Markup Language) 130e, tpaML (Trading Partner Agreement Markup Language) 130d, and WSFL (Web Services Flow Language) (not shown) specify business collaboration at the conversation business rule layer 123 as individual rules, although these protocol may include lower layers as well. The ebXML protocol 130e, which is a joint initiative of the United Nations Centre for the Facilitation of the Administration, Commerce and Transport (UN/CEFACT) and OASIS (Organization for Structured Information Standards), is an ebXML schema that specifies a business transaction in terms of individual rules for requests/responses (e.g., single-round document flows) and uses XML based messages. Thus, the ebXML protocol 130e is actually conversation business rule based.

Still referring to FIG. 1, tpaML 130d may be used to express the rules of business interactions. However, tpaML 130d focuses on bilateral agreement that could vary from partnership to partnership—even if for the same kind of business contact. Also the process specifications are developed from scratch and thus are more difficult to work with.

Still referring to FIG. 1, CrossFlow 130b, developed in the ESPRIT Project (European Strategic Program on Research in Information Technology), handles inter-process invocation at the process layer 124. However, it does not cover lower layers of the technology stack 120. While CrossFlow 130b may allow a workflow task to invoke another business process being run at a separate workflow engine, it addresses one-way invocation and integrates two or more different business processes.

Finally, WebLogic Process Integrator 130a also covers only the process layer 124 focusing on integrating different business processes. However, it does not involve lower layers of the technology stack 120 and does not focus on commonly agreed-upon protocols. Thus, none of the cited protocols cover all of the technology stack 120 and most cover just one or two layers.

The nature of the various protocols may make it difficult for two or more businesses to engage in e-commerce using the conventional protocol. Referring now to FIG. 2A, the process P is intended to be executed within a single company (e.g., by a single engine). The sub-process P′ is intended to be executed as a sub-process of process P. While theoretically possible to execute the sub-process in a second company, this leads to undesirable consequences. Thus, this method is not acceptable because none of the players desire to be the sub-process P′. It is undesirable for the enterprise running process P to reveal details to the other enterprises so that the other may implement the sub-process P′. Additionally, there are security and autonomy issues. Thus, the method of FIG. 2A, is better suited for a single business than it is for business-to-business interactions.

Another conventional protocol is invocation-based service provisioning, an example of which is CORBA. In FIG. 2B, the protocol allows an application process 150 (e.g., a consumer) to send a message 151 to a service process 160 (e.g., a provider). The service process 160 may then execute one or more tasks 140 before sending a reply 152. However, this says nothing about the process itself. The protocol itself (e.g., CORBA) only provides for sending a message 151 and waiting for a response 152.

However, business interactions using CORBA-like middleware infrastructures have several limitations. First, most of them are based on synchronous communications for networked devices to maintain continuous contact, which may be suitable for integrating tightly coupled local systems, but not for inter-business interaction and for coping with firewalls. Next, due to the difficulty of inter-enterprise security, privacy and trust, adopting a single such middleware by different enterprises is impractical. Further, inter-enterprise service provisioning is usually beyond simple application invocation; thus, there is a need for collaboration of the service providers and requesters.

Another conventional method is federated process management and federation. Referring now to FIG. 2C, a federated approach is shown. In this case, the processes are completely independent with a certain task 140 (step) having a dependency. For example, task 140a has a dependency on task 140b. The federation approach focuses on integrating different processes. The dependency allows for a process in the other business to run. For example, process A sends a document to process B; then process A waits for a response.

While the method of FIG. 2C is more autonomous and independent than the process of FIG. 2A, there is no way of controlling the dependency. For example, there is no control as to what happens when process B receives the document. Because process B has control, chaos may result. Thus, unfortunately, the agreement has to be made verbally, for example, by e-mail. Consequently, it is very difficult to enforce the rules and it is difficult to use such services across enterprise boundaries.

Another conventional method is RosettaNet. Referring now to FIG. 2D, in RosettaNet process C and process D agree to an interface. For example, they agree to a document and how to transfer the document. However, the processes themselves are not connected. Thus, it is entirely up to process C and process D to invoke the other Partner Interface Process (PIP). There is no agreement as to common logic. For example, when process D receives a document from process C it may not know with which process this document is associated. Therefore, process D cannot synchronize the exchange.

Still referring to FIG. 2D, the RosettaNet Consortium has placed the focus on defining standard interfaces between partners for business process integration. More specifically, the consortium is driving the development of Partner Interface Processes (PIPs) that define the “interface” tasks 140i in which supply chain partners commonly participate. Under PIPs, different internal processes of the partners are “interfaced” through individual “hand-shake” or conversation points 170. However, the PIP approach does not offer any general means for the partner processes (e.g., process C and process D) to synchronize.

As the diagrams in FIGS. 2A-2D illustrate, implementing business processes across enterprise boundaries may not be handled well, if at all, under conventional process management. Traditionally, a business process is centrally controlled. Although the tasks 140, or steps, that contribute to the accomplishment of the process, can be distributed, they are scheduled and dispatched by the centralized workflow server. When multiple parties belonging to different enterprises are involved in a business process, they are unlikely to rely on a centralized process management, because they are often separated by firewalls, have self-interests, and do not wish to share all the process data. Integrating different processes at any single engine faces the same level trust, security, and privacy issues. This has become the major impedance for using a centralized server for handling inter-enterprise business processes.

Thus, while some of the protocols do provide for managing inter-enterprise processes, they may require integration of different processes from the different participating enterprises. Furthermore, they require the use of a single process manager as the integration point. However, in an inter-enterprise application each party may desire to keep certain internal processing steps and data private. Therefore, it is difficult to reach agreement on the use of a single process engine.

### DISCLOSURE OF THE INVENTION

A method of implementing a collaborative business process is disclosed. The method comprises designing a collaborative business process to be executed by two or more players. The collaborative business process has a number of tasks. A number of roles are assigned to the collaborative business process and at least one of the roles is assigned to the tasks. The players instantiate a copy of the collaborative business process at their nodes and take a role in the collaborative business process. Therefore, the tasks are assigned to at least one player. Finally, the tasks are executed in synchronized fashion at the nodes for the players.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram showing the layers in a business technology stack that are covered by conventional protocols.

FIGS. 2A-2D are diagrams showing conventional methods of executing two distinct business processes.

FIG. 3 is a diagram showing a commonly agreed collaborative process being run at three nodes, according to embodiments of the present invention.

FIG. 4 is a diagram showing a commonly agreed collaborative process being run at two nodes, according to embodiments of the present invention.

FIG. 5 is a diagram illustrating a commonly agreed collaborative process executed by peer process instances, according to embodiments of the present invention.

FIG. 6 is a flowchart illustrating steps of a process of implementing a collaborative process, according to embodiments of the present invention.

FIG. 7 is a flowchart illustrating further steps of a process of implementing a collaborative process, according to embodiments of the present invention.

FIG. 8 is a diagram illustrating a document that may be exchanged during a collaborative process, according to embodiments of the present invention.

FIG. 9 is a diagram illustrating a specification for a Common Collaboration context, according to embodiments of the present invention.

FIG. 10 is a diagram of a specification for a role, according to embodiments of the present invention.

FIG. 11 is a diagram of a specification for a player, according to embodiments of the present invention. player

FIG. 12A is a diagram of a specification related to documents in a collaborative process, according to embodiments of the present invention.

FIG. 12B is a diagram illustrating document exchange between players, according to embodiments of the present invention.

FIG. 13 is a diagram of a collaborative process specification, according to embodiments of the present invention.

FIG. 14 is a diagram of an action specification, according to embodiments of the present invention.

FIG. 15 is a diagram illustrating a chain of collaborative processes, according to embodiments of the present invention.

FIG. 16A is a diagram of a task specification, according to embodiments of the present invention.

FIG. 16B is a diagram of an action specification that may be used with the task specification of FIG. 16A, according to embodiments of the present invention.

FIG. 17 is a flowchart illustrating steps of a process of instantiating and implementing a second collaborative process in a chain with another collaborative process, according to embodiments of the present invention.

FIG. 18 is a flowchart illustrating steps of a process of a node executing its portion of a collaborative process, according to embodiments of the present invention.

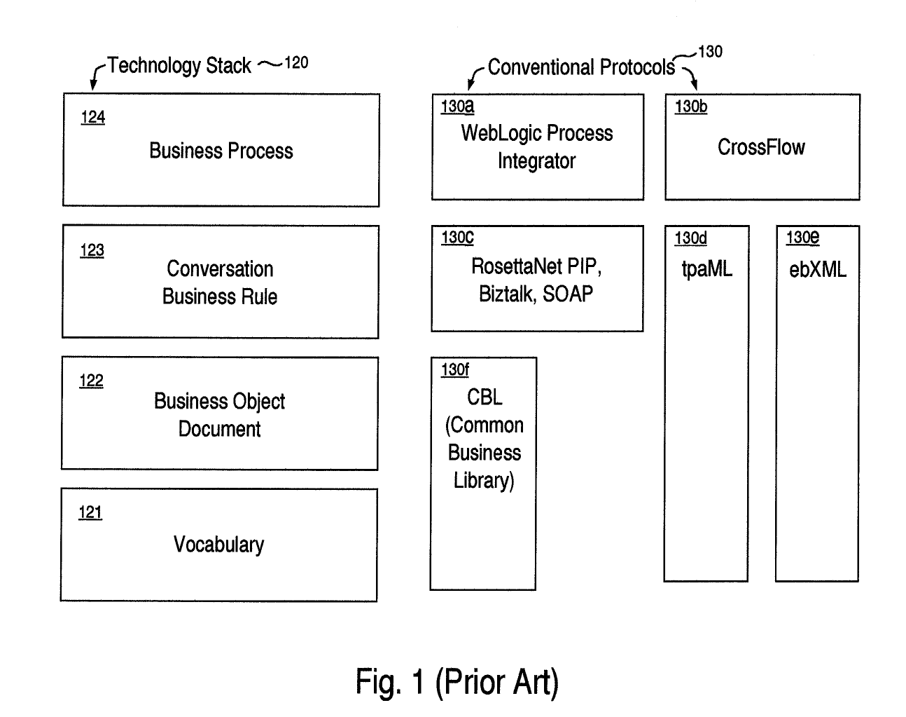

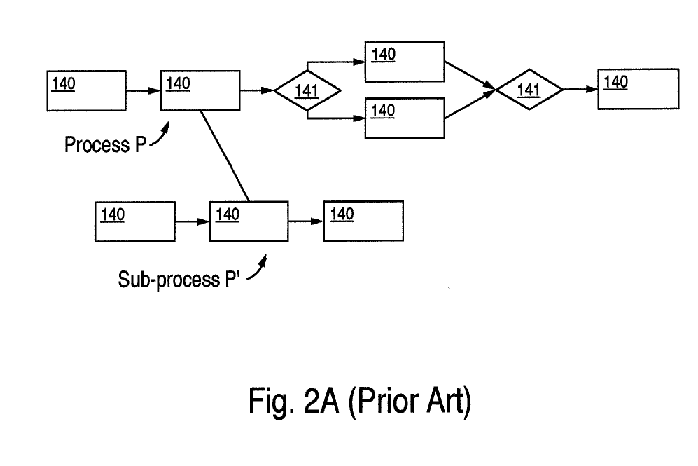

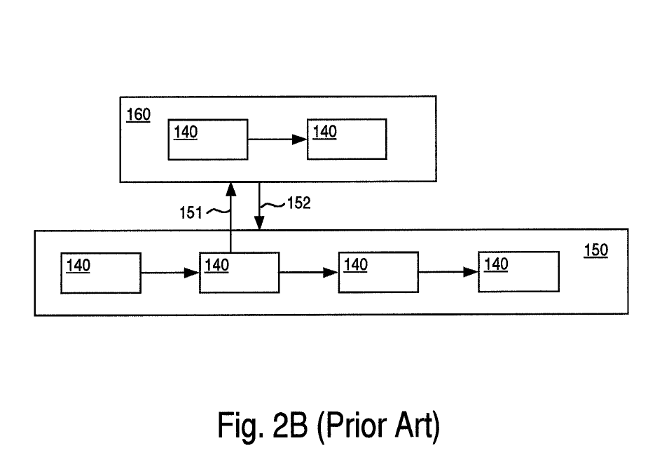

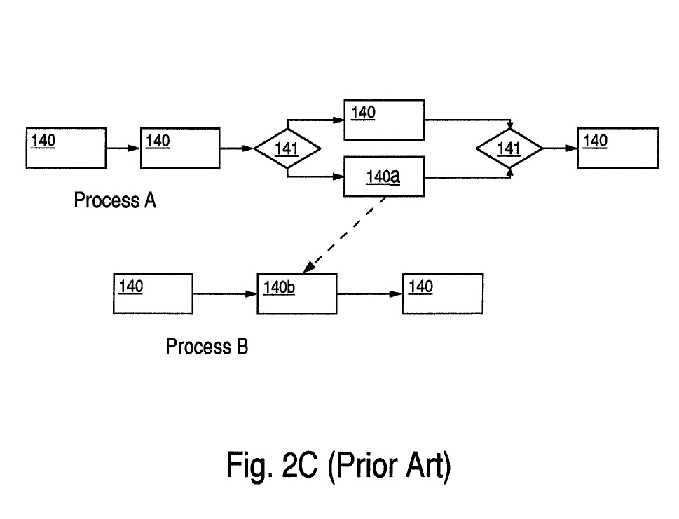

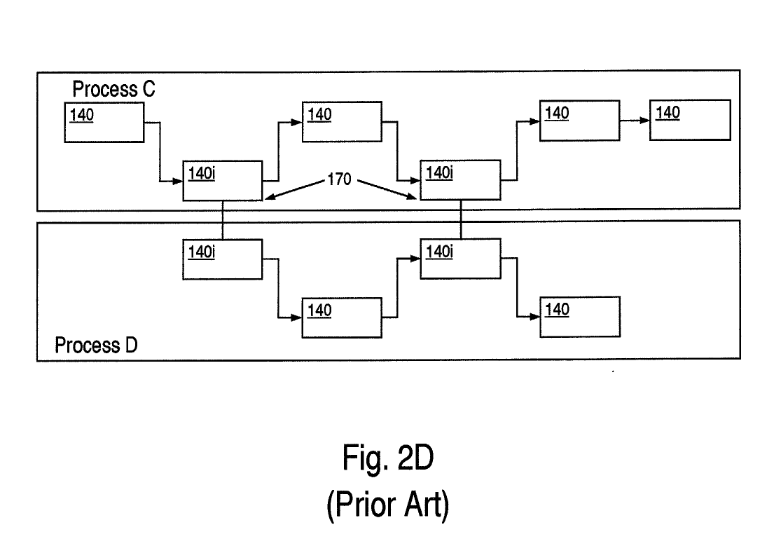

### BEST MODE FOR CARRYING OUT THE INVENTION

In the following detailed description of the present invention, numerous specific details are set forth in order to provide a thorough understanding of the present invention. However, it will be obvious to one skilled in the art that the present invention may be practiced without these specific details or by using alternate elements or methods. In other instances well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, etc., is conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “measuring”, “calculating”, “receiving”, “computing” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present invention is also well suited to the use of other computer systems such as, for example, optical and mechanical computers.

Embodiments of the present invention provide a method for implementing a collaborative process. Embodiments provide for a method, which does not require a single process manager as an integration point. Embodiments integrate multiple layers of the business process technology stack. These and other advantages of the present invention will become apparent within discussions of the present invention herein.

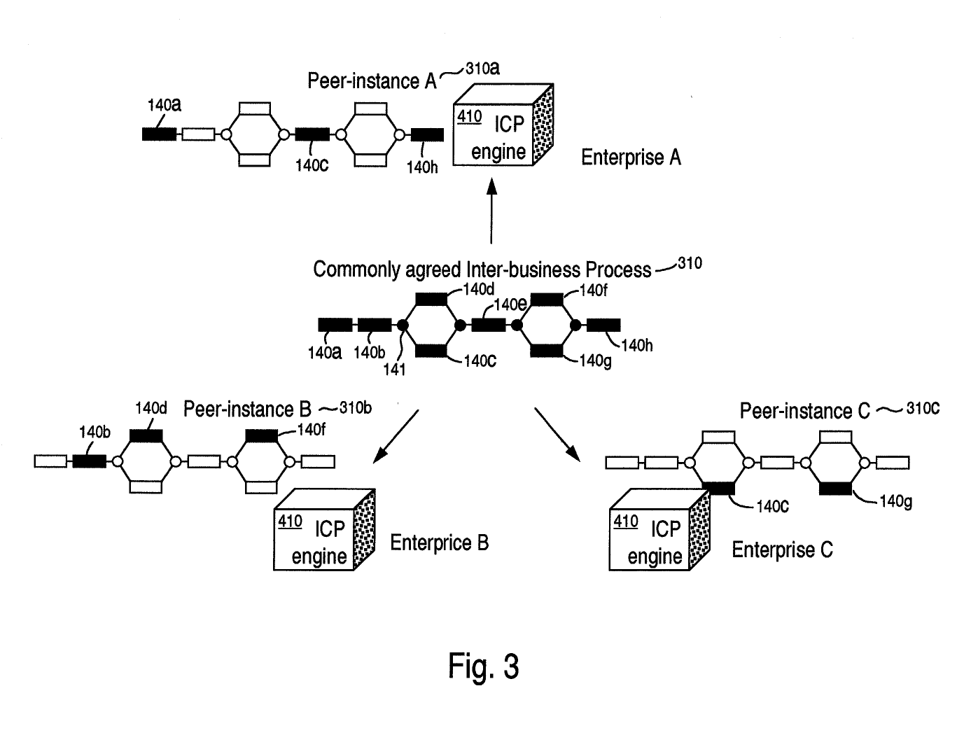

Referring to FIG. 3, embodiments of the present invention provide for a method of implementing a collaborative process 310. A collaborative process 310 may be executed at multiple nodes, with each node executing its assigned tasks 140 from the collaborative process 310. In various embodiments the collaborative process 310 may be an Inter-business Collaborative Process (ICP) 310 or a collaborative business process 310. Like a conventional business process, an ICP 310 may be modeled as a DAG (Directed Acyclic Graph). The ICP 310 may comprise a number of task nodes 140 (shown as rectangles in FIG. 3) and route nodes 141 (shown as circles in FIG. 3). The task nodes 140 may be associated with an activity to be executed either by a program (e.g. a software agent) or by a human worker. The route nodes 141 may specify the rules and conditions for flow control, process data update, etc.

However, the present invention is not limited to the collaborative process 310 being a collaborative business process 310 or an Inter-business Collaborative Process (ICP) 310. For example, the collaborative process 310 may be executed by nodes that are not business, such as between a business and a customer. Also, while embodiments describe the collaborative process 310 as a collaborative business process 310, the collaborative process 310 itself is not limited to what may be considered a business transaction or process. For example, embodiments of the present invention are suitable to execute, collaboratively, a process between two or more entities.

An ICP 310 may be defined based on a common agreement of all the participating parties. Instead of executing the process on a centralized workflow engine, each execution of the ICP 310 consists of a set of peer process instances (e.g., peer instances 310a, 310b, 310c) run by the peer engines 410 of the participating parties collaboratively.

Referring still to FIG. 3, embodiments extend process management from a one-server model to a multi-server peer-to-peer model, and embodiments shift from centralized process management to collaborative process management. During a process-level 124 business interaction, each partner (e.g., Enterprises A, B, and C) executes a peer process instance (e.g., 310a, 310b, and 310c) under the same collaborative process template (e.g., commonly agreed inter-business process 310). Each enterprise executes only those tasks 140 that are assigned to it. For example, enterprise A executes tasks 140a, 140c, and 140h. Enterprise B executes tasks 140b, 140d and 140f. And enterprise C executes tasks 140c and 140g.

The peer engine 410 of each party may be used to schedule, dispatch, and control the tasks 140 for which a party is responsible. The peer engine 410 may also synchronize their progress in process execution through a messaging protocol. Any suitable messaging protocol may be used. Further, document exchange may be implemented through such process synchronization.

To deal with the real complexity of inter-enterprise e-business, embodiments of the present invention provide for a common agreement at multiple layers of the technology stack 120. Further, embodiments address the business interaction at a layer selected to optimize processing. For example, embodiments elevate document exchange from the conversation business rule layer 123 to the process layer 124 of the technology stack 120. Thus, embodiments use integrated process definitions rather than describing interaction using individual rules. This may allow embodiments to cope with transactional e-business applications involving complex, concurrent, long-duration, long-waiting and nested tasks. Further, embodiments cope with the inter-enterprise nature of e-business by involving multiple autonomous and decentralized systems.

Embodiments support inter-business interaction among trading partners by arriving upon an agreement on common protocols at several levels of the technology stack 120. Such protocols may cover the vocabulary layer 121, the document (or business objects) layer 122, the conversation business rules layer 123, and the business process layer 124.

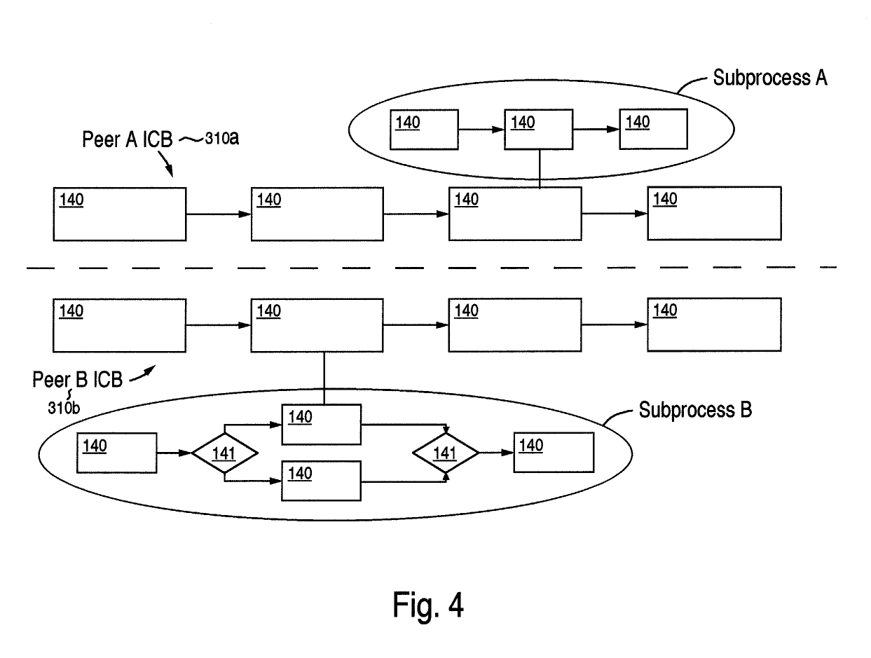

Referring now to FIG. 4, embodiments provide for an ICP 310 that expresses the process-level protocol of business interaction, while allowing complete independence of the internal processes (e.g., sub-process A and sub-process B) at each participating party. To situate the inter-enterprise nature of e-business, embodiments support peer-to-peer processes rather than centralized process management. For example, Peer A and Peer B are shown executing the same collaborative business process 310. Such a protocol based collaborative process execution may be conceptually different from the integration of different processes as is provided for by some conventional protocols.

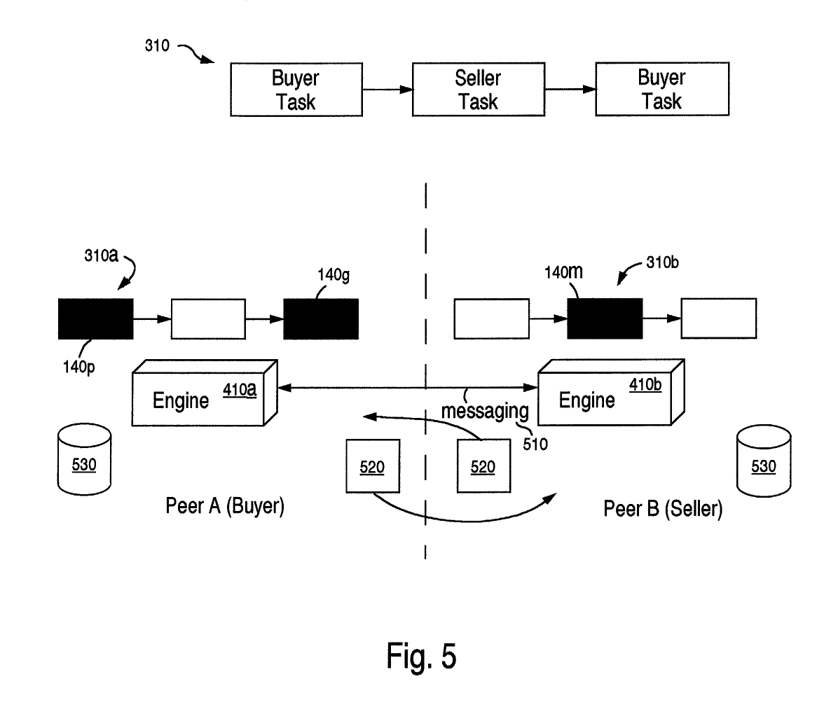

FIG. 5 illustrates an example showing a buyer and a seller executing a commonly agreed ICP 310 on separate engines 410. For example, when the buyer (Peer A) wants to make a purchase from a seller (Peer B), the buyer-side engine 410a creates a logical instance of the purchasing process, and initiates a “buyer-side” peer instance 310a. Peer A then notifies the seller-side engine 410b to instantiate a “seller-side” peer instance 310b of the purchase process. The peer process instances at both sides can be considered as autonomous but are following a purchase protocol with which both the buyer and the seller are willing to comply.

Still referring to FIG. 5, the ICP 310 has a number of roles associated with it. In this example, there is a buyer role and a seller role. Each task 140 is associated with one or more of the roles. For example, the server at the buyer side is only responsible for scheduling and dispatching the tasks 140 to be executed by the buyer, such as tasks 140p and 140q in FIG. 5. These may be, for example, tasks for preparing a purchase order and making a payment. Peer A skips the tasks 140 not matching the role of buyer, and simply waits for peer B (the seller side server) to handle its tasks 140. Similarly, the server at the seller side is only responsible for the tasks belonging to the seller, e.g., task 140m. The servers at both sites exchange task execution status messages 510 for synchronization.

Still referring to FIG. 5, the peers may also exchange documents 520. Thus, document exchange may be combined with peer-process instance synchronization. The documents may be based on common business objects, such as, for example, the Common Business Library (CBL). Thus, embodiments combine business object modeling and business process modeling, and cover all the layers of the technology stack 120 for business interaction. Each peer may also store data in a data container 530.

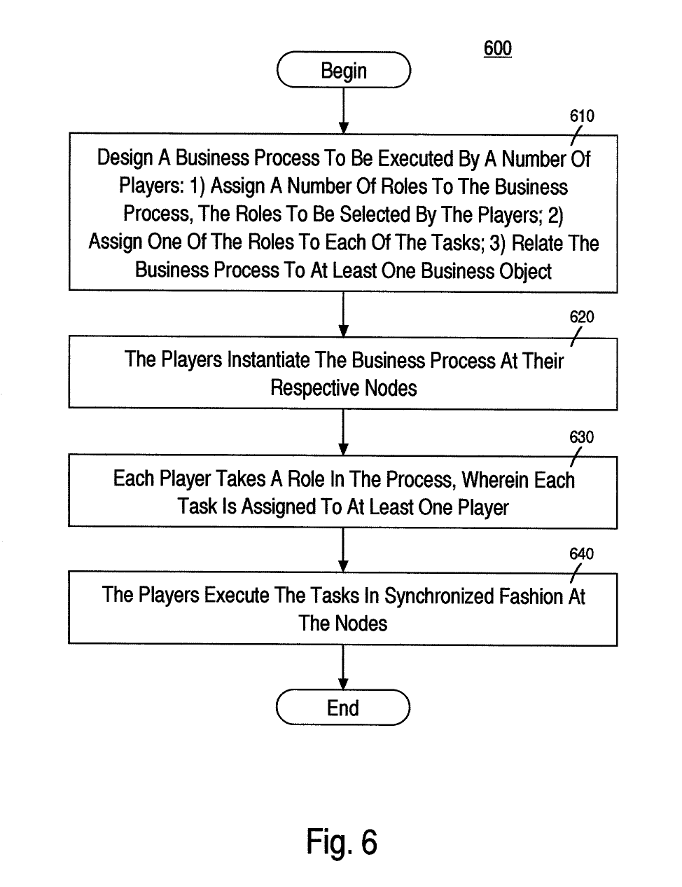

Referring now to FIG. 6 the flowchart illustrates a Process 600 for implementing a collaborative business process 310. In step 610, a collaborative business process (e.g., ICP) 310 to be executed by a number of players is designed. The ICP 310 involves multiple parties (or players) and defines a number of roles that the parties may select to play. The collaborative business process 310 is defined based on a commonly agreed operational protocol, such as a protocol for on-line purchase or auction.

Step 610 may be broken into sub-steps. First, assigning to each ICP 310 a list of process roles, indicating the logical participants. For example, a simple purchase process may have two roles, “buyer” and “seller”. Second, assigning a role to each task 140. The role may be selected from the process-roles. In the present example, tasks 140 can have roles “buyer” and “seller”. Third, relating the collaborative business process 310 to common business objects. For example, the collaborative business process 310 allows the peers to exchange documents that are based on common business objects (e.g., as defined by CBL).

In step 620, the players instantiate the business process at their respective nodes (e.g., with their respective engines 410). For example, a collaborative business process (ICP) 310 is defined with process-roles Ra, Rb, Rc, etc. Each logical execution of an ICP 310 consists of a set of peer process instances run by the players (e.g., engines 410) of the participating parties. These peer instances observe the same process definition but may have private process data and sub-processes. Each peer process instance has a role that must match one of the process-roles. An identifier is assigned to each logical execution of an ICP 310, to correlate and synchronize the peer executions of the same ICP 310; the unique identifier of that logical execution marks all the messages exchanged between the peer process instances.

In step 630, at the time the logical process instance of the process is created, each player takes a role in the collaborative business process 310, wherein each task 140 is assigned to at least one player. Thus, the players, Aa, Ab, Ac, etc., take a role in the process, Ra, Rb, Rc, etc. The creating player obtains a key (or identifier) for this ICP 310, creates a peer process instance Pa for itself, and associates this key with its peer process instance. The players may obtain the key from a third party or may generate the key themselves, the method is not critical. The player then sends the key to the other players, who create the peer process instances Pb Pc, etc., corresponding to the roles they chose.

In step 640, the players then execute the collaborative business process (ICP) 310 in synchronized fashion at their respective nodes, taking turns to execute the tasks 140 that are assigned to them based on their roles. The Process 600 then ends.

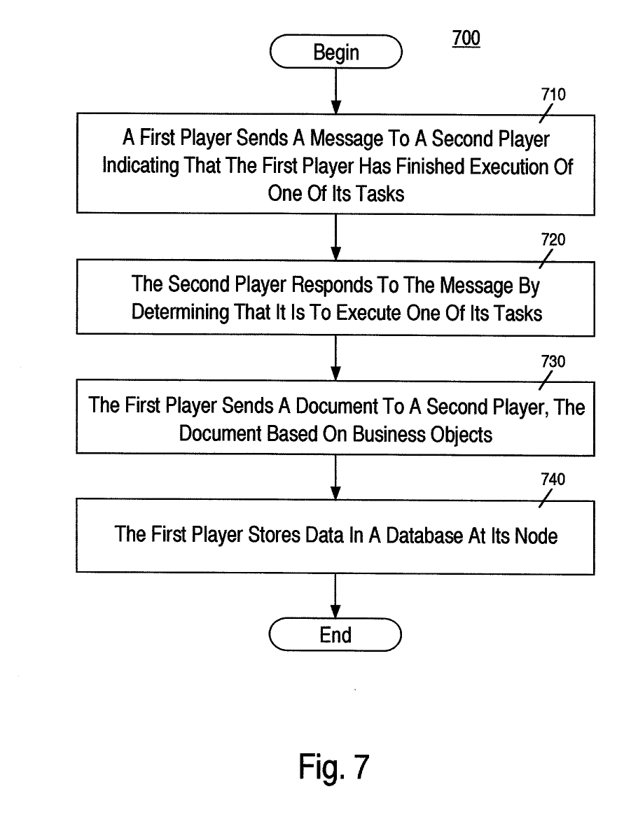

Referring now to FIG. 7, further details of step 640 of Process 600, in which the players execute the collaborative business process 310 in synchronized fashion, will be discussed. Process 700 of FIG. 7 is not limited to the order of steps as shown and not all steps need be taken. For illustrative purposes, assume that tasks Ti, Tj, Tk, etc., are to be executed in sequence by the players with roles Ra, Rb, Rc, etc., respectively. In step 710, a first player sends a message 510 to a second player indicating that the first player has finished execution of one of its assigned tasks 140. For example, player Aa, representing the process-instance-role of Aa, dispatches and executes Ti and upon receipt of a task return message, forwards it to all other players of the ICP 310. Then players Aa, Ab, Ac, etc., all update their process states and schedule the possible next task 140 of their own peer process instance based on that message.

In step 720, the second player responds to the message 510 by determining that it is to execute one of its assigned tasks 140. Other players simply wait. For example, when players Aa, Ac, etc., proceed to activity Tj (otherwise known as task Tj), they simply wait for the peer player, for example Ab, to handle it at the peer site, since the roles represented by them do not match the role of Tj. When Ab proceeds to activity Tj since the role represented by Ab matches that of Tj, Tj will be handled by Ab. The execution of peer process instances at all peers progresses in this way, towards their ends.

In step 730, the first player sends a document to a second player. The document may be based on a common business object. Common business objects are well known by those of ordinary skill in the art. The process data objects defining the documents may be specified with sharing scopes, such as public or role-specific. Public data is sharable by all process-roles (and thus by all peer process instances). The role-specific data objects are accessible to the peer process instances of the specified roles only. In this fashion, the data may be available to only one role or any subset of roles that are specified.

In step 740, the first player stores data in a database (e.g., container 530). An advantage gained from modeling inter-business interactions at the business process level 124 is the ability to preserve transactional properties. For each player, the documents exchanged, including those sent to and received from the peer players, are kept in the process data container 530, until all the process instances finish, and then made persistent (commit) or dropped (abort). Upon termination of the process execution, the peer engine 410 initiating the process instance, can act as the coordinator for executing, for example, the 2-Phase Commit protocol for synchronizing peer commitment. Introducing a coordinator ensures the consistency of the commit/abort decision, without assuming the use of any global database. The present invention is not limited to the initiating player to serve as the coordinator. Furthermore, the present invention is not limited to the 2-Phase Commit to synchronize the various databases 530.

Thus, each peer process instance maintains an individual process data container 530. Each task 140 is given a sub-set of the process data (e.g. documents) passed to or generated by the task 140. For, example, in one embodiment, an ICP 310 is associated with a process data container. When an activity is launched, a packet containing a subset of the process data is passed to it; when it is completed, together with task status information, the data packet is sent back for reconciliation with the process data, possibly updated during the task execution. Furthermore, the document generation and exchange steps, e.g., preparing business documents according to appropriate business logic, are handled as business process tasks 140. Process 700 then ends.

Thus, embodiments allow the combination of document exchange and synchronization of peer process instances. Most of the existing approaches separate the information interface and the activity interface of inter-business collaboration. Under those approaches, document exchanges are made at the action layer rather than at the process layer 124. Embodiments of the present invention integrate the information and actions of a business interaction into a single ICP definition 310, making task flow naturally consistent with the document flow.

An action for a task 140 may be dispatched to a software agent or a human user to perform, and upon its termination, a task return message 510 is sent back and used to trigger the next step (task) 140 in collaborative business process 310 execution. Such a task return message 510 contains not only the identification and status information, but also the subset of process data passed to or generated by the action.

When a task return message 510 comes back to the local ICP engine 410, the subset of the process data passed to the action must be reconciled with the process data after returning. However, before such a message 510 is forwarded to a peer player for synchronizing peer process execution, only the updated data elements that are shared with the player are retained (the sharing scope of each data-element is specified in the process definition). A forwarded task return message 510 can carry the appropriate business documents to be delivered. This allows embodiments to integrate document exchange with inter-enterprise collaborative process management.

Embodiments allow e-business interaction to be based on a document service architecture, which takes documents as the basic business objects and document exchange as the basic business interface. The document service architecture enables an enterprise to interact with other enterprises, while shielding it from changes in internal implementation, organization, and processes that might occur in the other enterprises. This elevates business-to-business integration from the system level (invoking applications through API function calls, as is the case with traditional distributed computing infrastructures such as CORBA) to the business level 124. Defining a business interface in terms of documents rather than APIs also allows for an incremental path to business automation, since applications can be initially handled manually through a web-browser interface, before migrating to fully automated processing.

To achieve this, embodiments define an XML based Common Business Collaboration Description Language (CBCDL), by adopting the Common Business Library (CBL) at the business objects layer 122. Embodiments extend the Process Definition Language (PDL) for specifying ICPs 310 at the business process layer 124, rather than by introducing new standards from scratch.

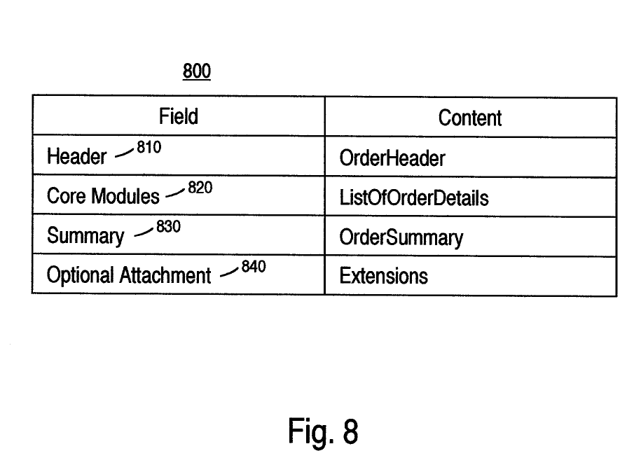

Embodiment may be able to provide reusable semantic components common to many business domains. Such components can be understood by any business through their common elements (such as address, date, part number, telephone number etc.). Embodiments of the present invention define a protocol based upon a set of XML building blocks and document templates commonly used in businesses. This provides vocabulary (syntax and semantics) for business concepts, as well as standard document templates for interchanging. The business concepts include business description primitives, such as, for example: company, service, product; business forms, such as, for example: catalog, purchase order, invoice; and standard measurements, such as, for example: data, time, location, etc. The document templates, for example, as published by Commerce-Net in xCBL 2.0, include PurchaseOrder, PurchaseOrderResponse, OrderStatusRequest, OrderStatusResult, Invoice, ProductCatalog, etc. Referring to FIG. 8, each document 800 may have a header 810, several core modules 820, a summary 830, and certain optional attachments 840. FIG. 8 shows an exemplary PurchaseOrder document 800.

Embodiments are based on the Document Object Model (DOM), allowing XML based CBL documents 800 to be easily turned into Java classes. For manipulating documents 800 programmatically, embodiments provide a set of Java classes as the counterpart of CBL document templates, and develop agents for loading, maintaining, exchanging and processing document classes and instances.

Conventional CBL documents are passive, informative objects. Embodiments change this in the following ways. First, associated with each type of CBL document 800 (e.g., PurchaseOrder), an enterprise-internal business process for processing the CBL object can be specified. Accordingly, a CBL object can be used to instantiate the corresponding business process with the specific information contained in the CBL document 800.

Next, document level business rules (e.g., at the conversion business rule layer 123) can be defined based on CBL document exchange. For example, the following rule is defined based on the exchanges of three types of CBL documents 800 in an application-specific context. If a purchase order is received, then an invoice and a shipping notice are to be sent back as reply. Further, the allowable sequence of such rules may be specified as a business process (e.g., at the business process layer 124).

Embodiments provide tools for generating CBL oriented data access and processing programs based on the object DTDs (Document Type Definition). A DTD (like a schema) provides a grammar that tells which data structures can occur, and in what sequence. Such schematic information may be used to automatically generate programs for basic data access and processing, e.g., creating classes that recognize and process different data elements according to the specification of those elements. For example, from a document 800 including the tag SHIPPING-DESTINATION, a Java method “getShippingDestination” may be generated, provided that the meanings of tags are understood, and a CBL oriented XML parser is appended to the JDK (Java Development Kit) classpath. Embodiments of the present invention may use any suitable XML parser.

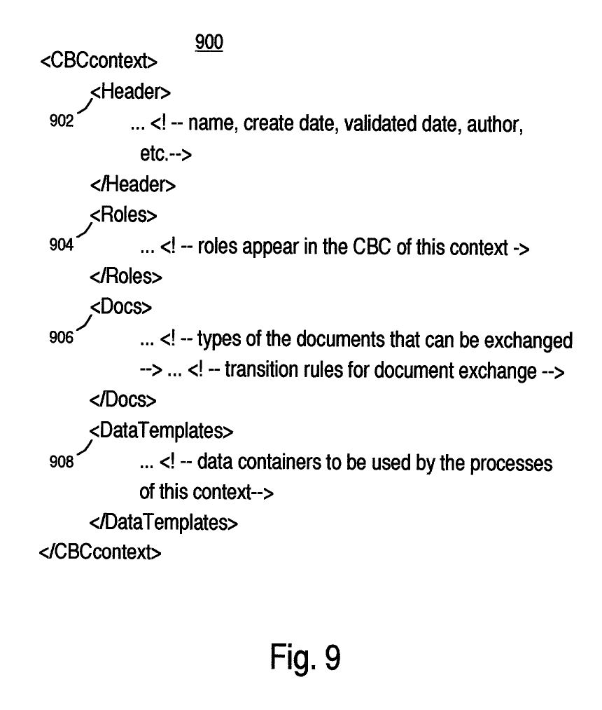

Embodiments of the present invention group collaborative business applications into Common Business Collaboration (CBC) contexts. An exemplary top-level XML structure of a CBC context 900 is shown in FIG. 9. The exemplary structure comprises a <header> tag 902 for information such as, for example, name, creation date, validation date, author, etc. The CBC context 900 comprises a <roles> tag 904 for the roles that appear in the CBC of this context. It comprises a <Docs> tag 906 for the types of documents 800 that may be exchanged in this context as well as the transition rules for document exchange. Finally, it comprises <datatemplates> tag 908 to specify the data containers to be used by the processes of this context.

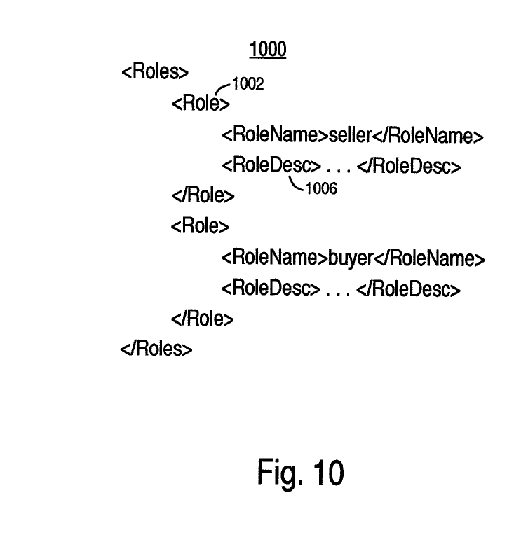

Referring now to FIG. 10, to facilitate inter-business interaction embodiments of the present invention distinguish the role of each participating party. For reusability, a CBC definition for a role specification 1000 only specifies the roles rather than specific party names that can play the corresponding roles. An exemplary role specification of FIG. 10 comprises two roles: a buyer and a seller. Each role is defined by its own <role> tag 1002, within which is a <Rolename> tag 1004 and a <RoleDesc> tag 1006. The present invention is well suited to any number and type of roles. Thus, each <Role> tag 1002 gives the information of a specific role.

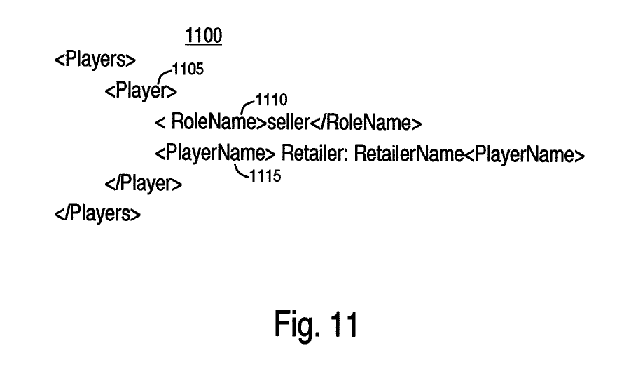

During business collaboration, such as executing an ICP 310, a party must be bound to a role to become a player of the ICP execution. However, a party may be bound to different roles in different process executions. Player specification is not part of the static ICP definition, but enclosed in the messages 510 for initiating ICP executions. An XML structure of a player specification 1100 is shown in FIG. 11. The exemplary player specification 1100 comprises a <player> tag 1105, which contains a <RoleName> tag 1110 and a <PlayerName> tag 1115. Thus, a given role may be associated with a given player. For example, FIG. 11 shows a seller role being taken by the player named retailername. It may be stated that an embodiment provides for a protocol in which the player specification or structure 1100 is for dynamically specifying the role a first player is to take in the collaborative business process 310, with the structure to be sent by the first player when the collaborative business process 310 is being executed to bind the first player to the role.

Externally to CBC context specifications 900, information about the potential players, e.g., the enterprises such as Retailer:

Retailername may be given in a business registry, including address, e-mail, URL and transport protocol (e.g., http), etc. The binding of a player to a role is dynamic, allowing a player to play different roles in different ICP executions. In fact, a single ICP engine 410 belonging to a party can execute multiple ICPs 310 concurrently and play multiple roles simultaneously in these executions.

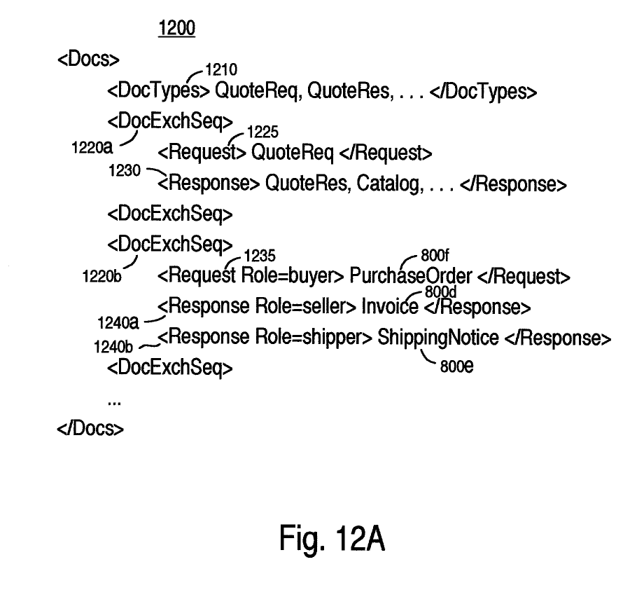

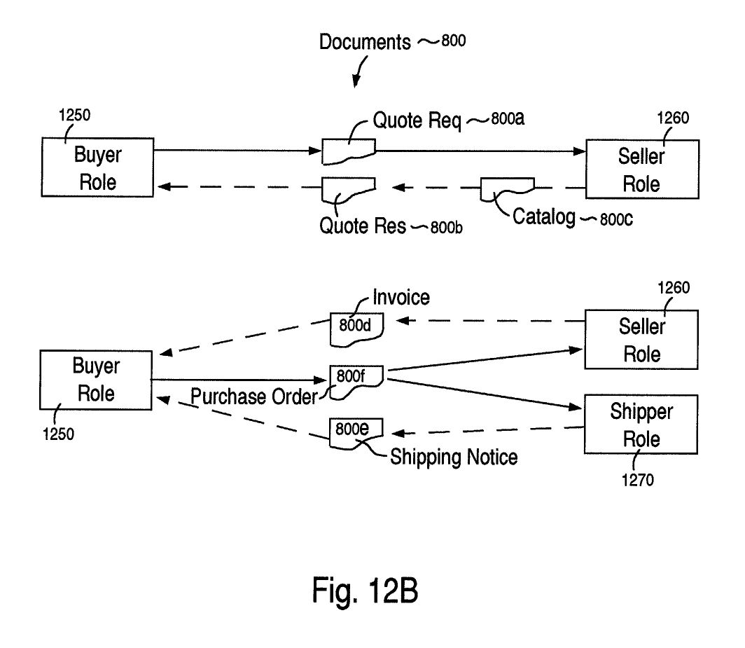

Referring now to FIG. 12A, an exemplary <docs> specification 1200 comprises a <DocTypes> tag 1210, which specifies the document types allowed in the CBC context 900. Also included are typing rules for document exchange (e.g., conversation). Thus, a <DocExchSeq> tag 1220a defines the sequence of document exchange. For example, under the first <DocExchSeq> tag 1220 the <Request> tag 1225 defines the document as a QuoteReq (Request for Quotation). Under the <Response> tag 1230 the documents are specifies as QuoteRes and Catalog.

Referring now to FIG. 12B, the buyer role 1250 is seen as sending a QuoteReq document 800a to the seller role 1260, who responds by sending a QuoteRes document 800b and a Catalog document 800c. Thus, corresponding to each in-bound document 800 for a request, there may be multiple possible out-bound documents 800 as response. Other general properties of document exchange, such as digital signature, are optional.

Conversation control may be role-sensitive and context-specific. Embodiments allow a role to be assigned to a particular document as follows. Referring again to FIG. 12A, under the second <DocExchSeq> tag 1220b, the Role=Buyer in the <Request> tag 1235 for the PurchaseOrder Document 800f. The Role=Seller in the <Response> tag 1240a for the Invoice document 800d, and the role=shipper in the <response> tag 1240b for the Shipping Notice Document 800e.

Referring again to FIG. 12B, the buyer role 1250 is seen sending the purchase order document 800f to both the seller 1260 and to the shipper 1270. The seller role 1260 responds by sending the invoice document 800d to the buyer role 1250. Furthermore, the shipper role 1270 responds by sending a shipping notice document 800e to the buyer role 1250.

Embodiments of the present invention may possess the following properties. Document exchange may be context sensitive, and therefore may be enclosed in <CBCcontext> 900. Document exchange may be role-sensitive but this is optional. A DataTemplate 908 may hold the definitions and initial values of process data objects, including CBL document templates. These data objects may be updated during ICP execution. The process state transition as a result of document exchanging may be encapsulated in ICP process definitions. The typing rules of document exchange may be used to validate ICP definitions and may be enforced during process execution.

### Exemplary ICP Specification

In one embodiment, the ICP specification language is based on an extension the standard Process Definition Language (PDL), as defined by the WFC (Workflow Coalition). In one embodiment, the ICP specification language may be in XML format. When compiled, it may first be translated into a DOM (Document Object Model) tree of Java objects, then into a Java class for cooperative process definition. However, the present invention is not limited to basing the ICP specification language on PDL. Nor is the present invention limited to XML for defining an ICP specification language.

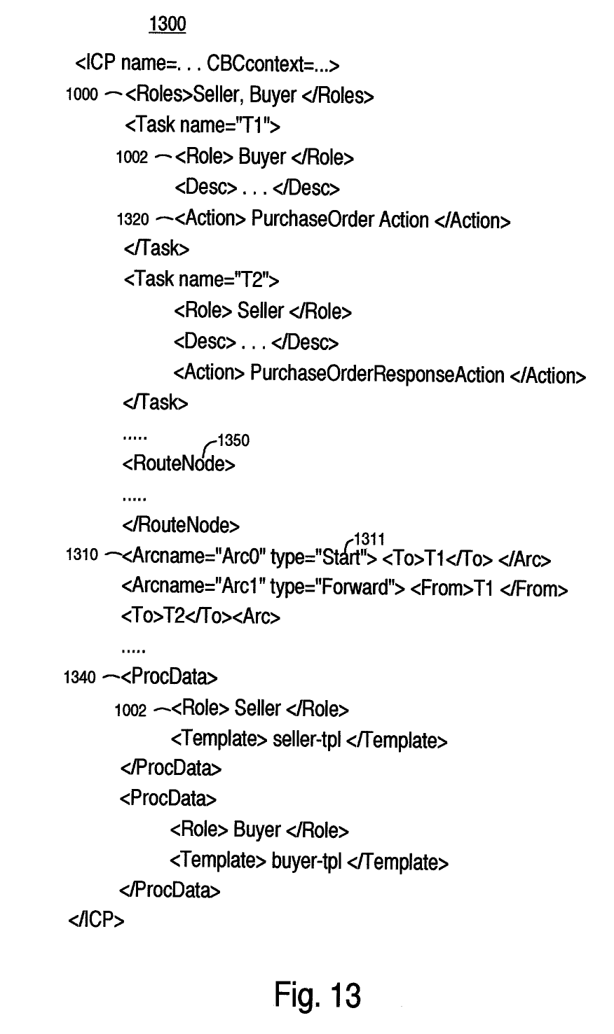

An exemplary ICP specification 1300 is illustrated in FIG. 13. The exemplary ICP specification 1300, along with other structures, may be suitable for implementing a protocol for a collaborative business process 310 to be executed by multiple players. The ICP specification 1300 includes a structure to specify the sequence in which the tasks are to be executed. For example, referring to the <Arcname> tag 1310, each ICP specification 1300 has a start point, e.g., the node with an in-bound arc with type “start” 1311. Also, there may be one or more termination points, e.g., the nodes without an out-bound arc (not shown). In between there may be points such as Arcname=arc1, which connects task T1 with task T2.

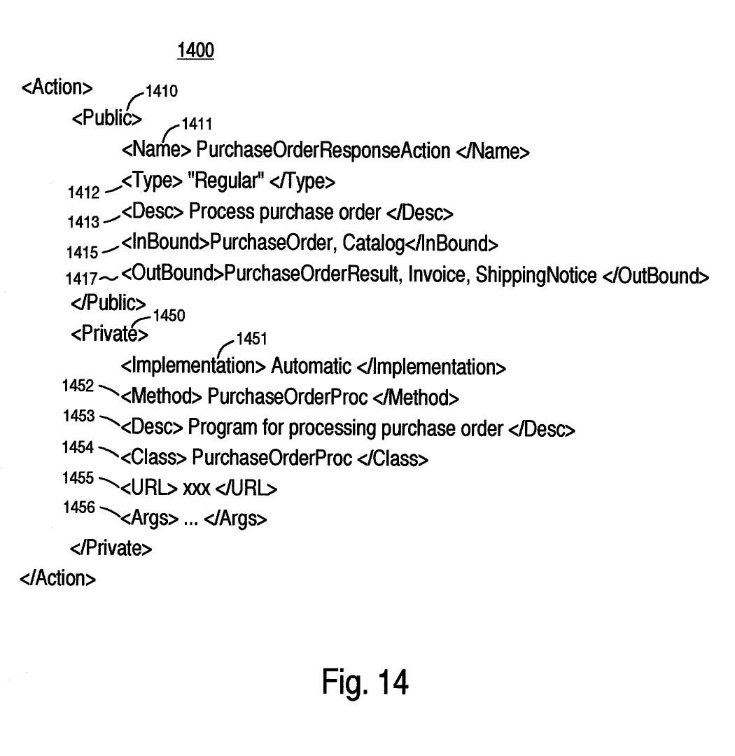

The collaborative business process 310, tasks 140, and process data are role-sensitive, in this example. The collaborative business process 310 may be role sensitive by including in the ICP specification 1300 a <roles> tag 1000, which specifies a list of process-roles such as “buyer” and “seller” to indicate the logical participants. The role of a task 140 must match one of the process-roles, in this example. The task 140 may be made role sensitive by the <role> tag 1002 as well. In this example, task name T1 is defined as buyer role by a <role> tag 1002. An <Action> tag 1320 defines task T1 as a Purchase Order Action. The Action Specification is discussed in conjunction with FIG. 14. In a similar fashion, Task T2 is defined as a seller role and as a Purchase Order Response Action.

Also included in the exemplary ICP specification 1300 is a <ProcData> tag 1340, for process data. This may also be made role sensitive by the inclusion of a <role> tag 1002, as seen in FIG. 13. However, the data need not be role sensitive. In an inter-enterprise collaborative process execution, each party may want to keep some of the process data private. In the <ProcData> specification 1340, a data template holding the definitions and initial values of process data objects (documents 800) can be specified with appropriate sharing scope. Thus, a template or a data object specified in a template, may be public, e.g., data is sharable by any process-roles (and thus by any peer process instances). Alternatively, the template may be process-role specific, e.g., a role-specific template is used by the peer process instances of the given roles (one or more) only, and such templates can be made different for different process-roles.

Consider a collaborative business process 310 with roles “buyer”, “seller”, and “bank”. Some data are private to “buyer”, some are sharable by “buyer” and “seller”, and some are public to all three roles. A process data container can be updated or expanded at peer process run time. Thus, the data may be assigned to exactly one of the roles, wherein the data is private. Alternatively, the data container may be assigned to a plurality of the roles, wherein the data is public. On the other hand, the data container may be assigned to a subset of all of the roles in the process, wherein the data is semi-public.

Finally, the ICP specification 1300 of FIG. 13 includes <RouteNode> tags 1350 for defining route nodes which may specify the rules and conditions for flow control, process data update, etc.

### Exemplary Action Specification

Referring now to FIG. 14, an action specification 1400 may contain two parts: a public interface 1410 and a private interface 1450. Under the public interface 1410 the Name 1411, Type 1412, Version, Timeout, Description 1413, etc., may be specified. The Public interface 1410 in the example is for a Purchase Order response Action, thus may be used to specify the action to be taken in task 2 in the ICP specification 1300 of FIG. 10. The Type 1412 of an action can be “Regular” (default) or “Cancel” (compensate on failure). InBound 1415 and OutBound 1417 documents consistent with the typing rules of document exchange, may be specified. Optionally, another action for canceling the effects of this action may be given.

Still referring to FIG. 14, under the private interface 1450, the enterprise internal dispatching information of an action may be given, such as who will be the physical or logical actor for performing the action. The Implementation 1451 of an action can be “Automatic” (e.g., by a program), “Manual” (e.g., by a user through a Web interface), or “Process” (e.g., an ICP 310 or a private sub-process is to be invoked for that action). When an action represents a program, information about downloading that program may be given.

Still referring to the Private interface 1451 of FIG. 14, also included are a <Method> tag 1452 for defining the method, a <Desc> tag 1453 for describing the interface, a <Class> tag 1454 for defining the class, a <URL> tag 1455 for providing a Uniform Resource Locator, and an <Args> tag 1456 for specifying arguments. Other tags may be provided as well.

### Process Nesting and Association

A task 140 may represent a “private” sub-process. The sub-process binding is dynamic, for example, it may be bound at run time; thus allowing it to be designed separately from the host process. The process data of a private sub-process may be entirely internal to the parties executing the sub-process.

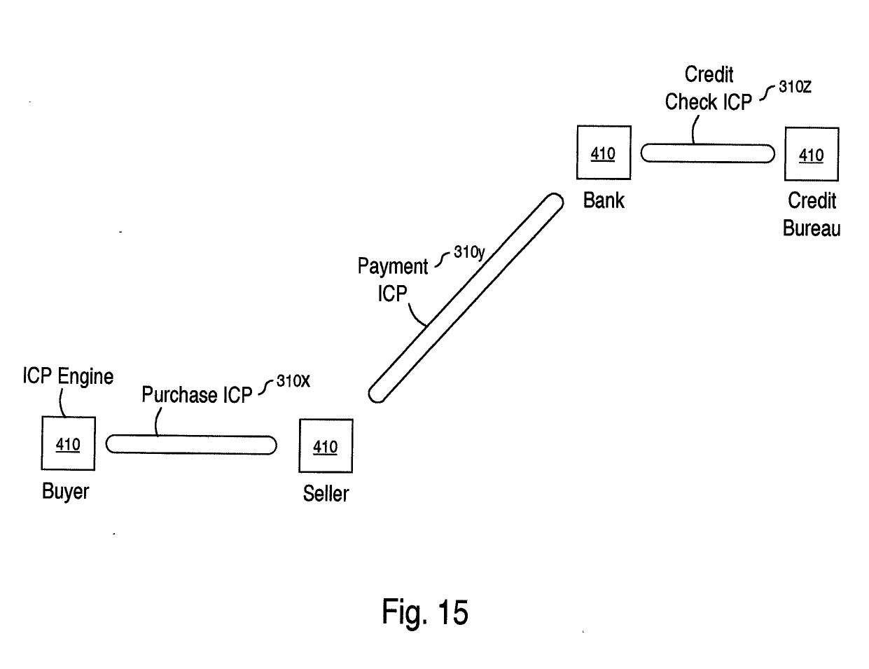

Referring now to FIG. 15, three collaborative business processes (ICPs) 310 are chained together. One of the collaborative business processes 310 may be described as a task within another collaborative business process 310. Thus, the buyer and seller are executing a purchase ICP 310x on their separate engines 410, the seller and the bank are executing a payment ICP 310y, and the bank and the credit bureau are executing the credit check ICP 310z. The payment ICP 310y may have a task that is implemented as the credit check ICP 310z, for example. For example, in the payment ICP 310y, a credit check task may be assigned to the role of the bank. This task may be performed as a sub-process that is also an ICP between the bank and the credit bureau.

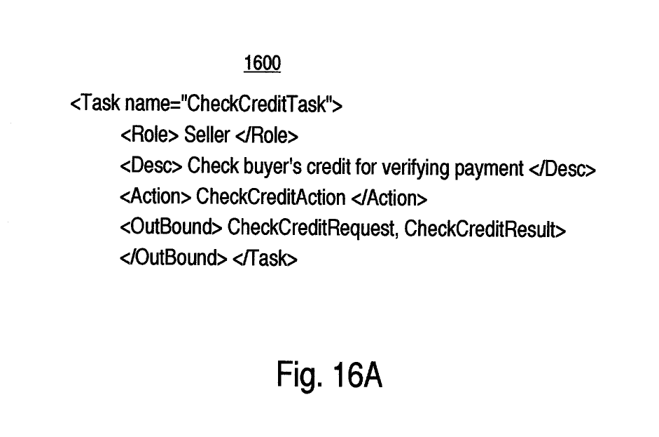

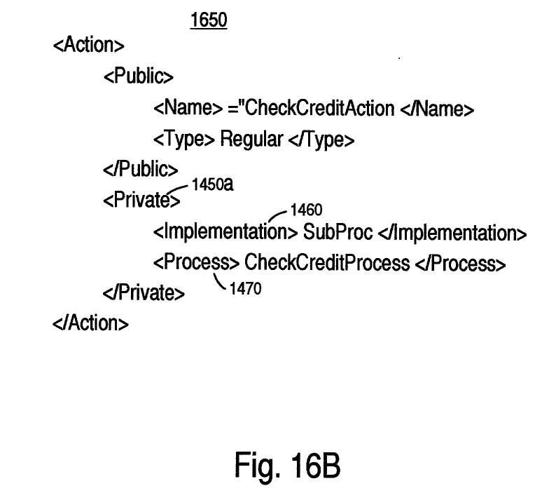

The exemplary specification of FIG. 16A defines a task name specification 1600 for a check credit task, which may be a task in the payment ICP 310y. Included in the check credit task is an action of “CheckCreditAction”. The Check Credit Action specification 1650 of FIG. 16B defines the action for this check credit action. In particular, the private interface specification 1450a defines the <Implementation> tag 1460 as being a sub-process and also defines the <process> 1470 as being “CheckCreditProcess”. For example, the task CheckCreditTask is executed by the peer playing the role of “Bank”. This task 140 is performed as a sub-process, CheckCreditProcess, that is also an ICP 310 between the “Bank” and the “Credit Bureau”, without involving the peer playing the role of “Buyer”.

Conceptually, there may be a symmetry in the sub-process relationship. From the purchase ICP 310x point of view, the payment ICP 310y can be considered as a sub-process representing a necessary step (e.g., task) of the purchase ICP 310x. From the payment ICP 310y point of view, the purchase ICP 310x may be considered as a sub-process representing a sufficient step of the payment ICP 310y.

In fact, in a multi-party collaboration environment, the ICPs 310 associated in an application context may form a fabric. Thus, e-businesses may be built on the services of one another. For instance, a multi-party e-business application is viewed as the composition of the following three processes: 1) the purchase ICP 310x between the buyer and the seller; 2) the payment ICP 310y between the seller the bank; and 3) the credit checking ICP 310z between the bank and the credit bureau.

These ICPs 310 are associated with overlapping players. However, the parties participating in an ICP 310 only agree on the ICP 310 definition, but not necessarily on the association of that ICP 310 with other ICPs 310. For example, besides the finally resulting document to be used in the purchase ICP 310x, the internal steps and data of the credit checking ICP 310z are invisible to the player buyer of the purchase ICP 310x.

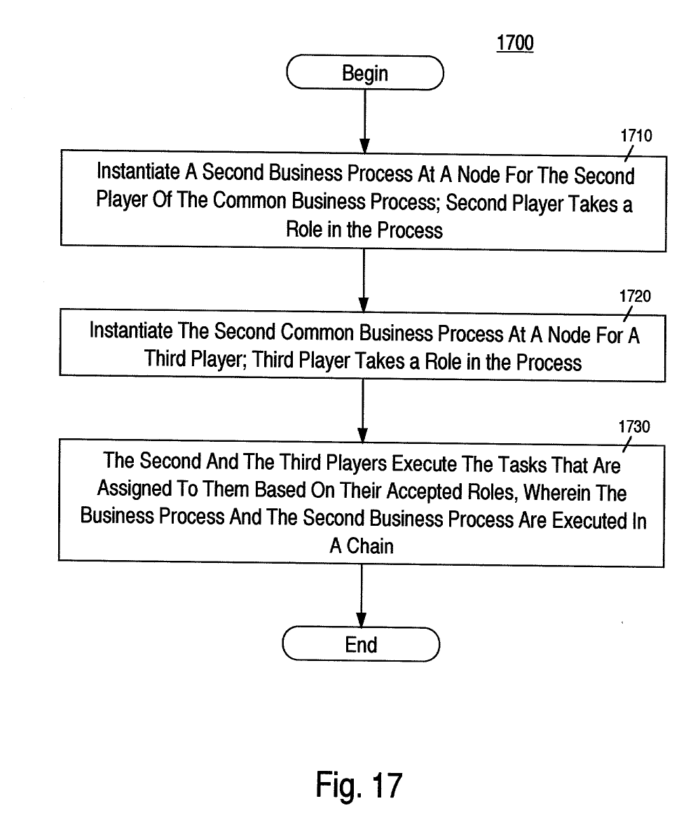

Referring now to FIG. 17, a process 1700 of chaining collaborative business processes 310 or executing a second business process 310 as a task 140 within a first collaborative business processes 310 is described. The process 1700 may be looked at as an extension of Process 600 of FIG. 6. For illustrative purposes assume that the buyer in FIG. 15 is a first node and the seller is a second node and that they are executing a collaborative business process (e.g., the purchase ICP 310x). In step 1710, the second node (e.g., the seller) instantiates a collaborative business process 310, for example, the payment ICP 310y.

In step 1720, a third player (e.g., the bank) instantiates the second collaborative business process 310y at its node and takes the role of the bank.

In step 1730, the second player and the third player execute the tasks that are assigned to them based on their roles. Thus, the collaborative business process 310x and the second collaborative business process 310y are executed in a chain. The particular collaborative business processes 310 that are chained are exemplary.

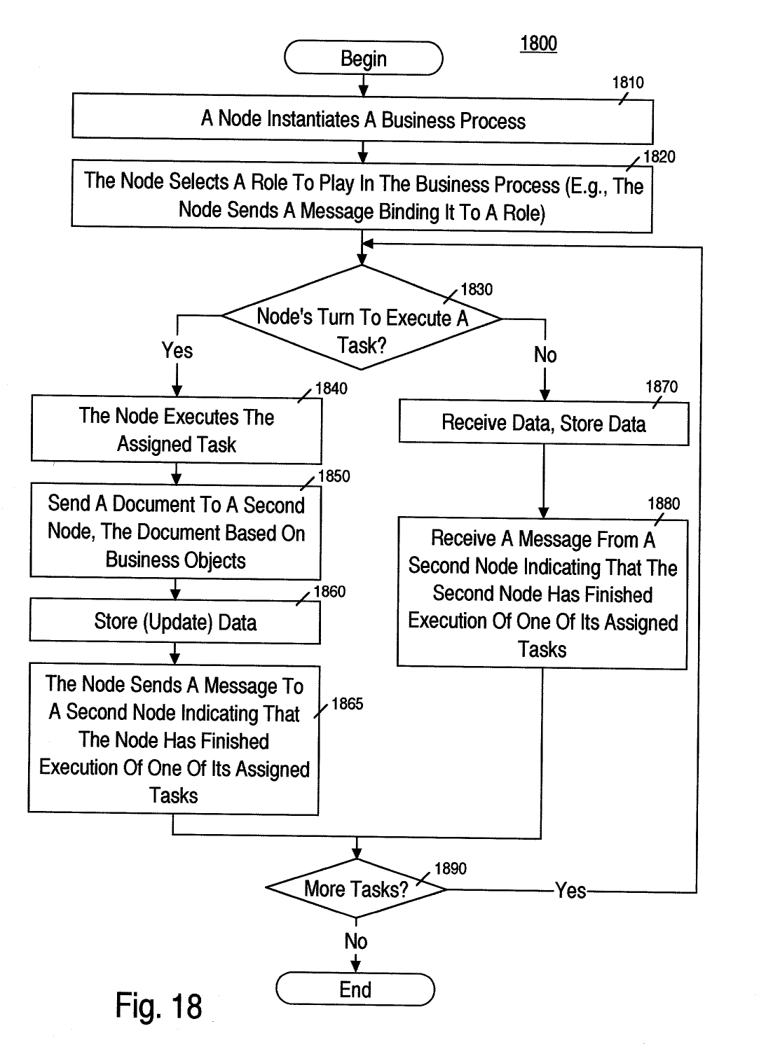

An embodiment may be described as a process of executing a portion of collaborative business process 310. For example, a node (e.g., ICP engine 410) may execute these steps. Steps of Process 1800 of FIG. 18 may be stored on a computer-readable medium, such that they will execute steps of process 1800 when run on a processor. For example, steps of process 1800 may be executed in a computer system comprising a processor coupled to a computer-readable medium via a bus. In step 1810, the node instantiates a collaborative business process 310. The node 410 may also send a key to other nodes 410 executing the collaborative business process 310, the key identifying the collaborative business process 310.

In step 1820, the node 410 selects a role to play in the collaborative business process 310. For example, the node 410 may send a message 510 that binds it to a specific role. For example, a player specification 1100 may be sent as a message 510.

In step 1830, the node 410 determines if the current task 140 in to be executed in the collaborative business process 310 is assigned to it, based on its role in the collaborative business process 310.

If the current task 140 is to be performed by the node 410, the node 410 executes the task 140, which may include steps 1840-1860 of process 1800. This may include sending a document 800, which may be based on common business objects, to other nodes 410 in the collaborative business process 310. The node 410 may also update its database 530 during this line of the process 1800. The node 410 may also execute a sub-process, which may be specific to this node 410 in that other nodes 410 are unaware of the steps in the sub-process.

Then in step 1865, the node 410 sends a message 510 indicating it has completed its task 140 wherein the node 410 and other nodes 410 execute the collaborative business process 310 in synchronized fashion.

If the current task 140 is not assigned to the node 410, the node simply waits for another node 410 to execute the task 140, in step 1870. The node 410 may receive a document 800 from another node 410 in branch of process 1800. The node 410 may also update its database 530 during this branch of process 1800.

In step 1880, the node 410 is signaled that another node 410 has finished its task 140 when the node 410 receives a message 510 from the other node 410 that it has completed its task 140.

In step 1890, the node 410 determines if there are more tasks 140 to perform in the collaborative business process 310, in which case it returns to step 1830. When all tasks 140 have been completed, the process 1800 ends. Thus, the node 410 executes a portion of the collaborative business process 310, with other nodes 410 performing the rest of the same collaborative business process 310. Furthermore, the node 410 may execute a number of collaborative business processes 310 simultaneously.

The preferred embodiment of the present invention, a method of implementing a collaborative business process, is thus described. While the present invention has been described in particular embodiments, it should be appreciated that the present invention should not be construed as limited by such embodiments, but rather construed according to the below claims.

We claim:

1. A method of implementing a collaborative business process, said method comprising:
a) designing said collaborative business process to be executed by a plurality of players, said collaborative business process comprising a plurality of tasks;
b) assigning a plurality of roles to said collaborative business process, said roles to be selected by said players;
c) assigning said plurality of roles to said plurality of said tasks, wherein said tasks are to be executed by the player that selects the role assigned to a given of said tasks;
d) instantiating said collaborative business process at a plurality of nodes, one node for each said player;
e) said players taking said roles in said collaborative business process, wherein said tasks are assigned to at least one of said players; and
f) executing said collaborative business process in synchronized fashion at said plurality of nodes.

2. The method of claim 1, wherein e) comprises a first player of said plurality sending a message to bind said first player to said role taken by said first player.

3. The method of claim 2, wherein said message comprises an XML structure specifying a name for said first player and said role taken by said first player.

4. The method of claim 1, wherein f) comprises a first player of said plurality of players sending a message to a second player of said plurality of players indicating that said first player has finished execution of one of its said assigned tasks.

5. The method of claim 4, further comprising:
g) said second player receiving said message and determining that it is to execute one of its assigned tasks.

6. The method of claim 1, wherein f) comprises a first player of said plurality of players sending a document to a second player of said plurality, said document based on business objects.

7. The method of claim 1, wherein f) comprises:
f1) instantiating a second collaborative business process at a node of said plurality in d) for a second player of said plurality of players, said second collaborative business process comprising a plurality of tasks having roles assigned to them;
f2) instantiating said second collaborative business process at a node for a third player, said third player not a player in said collaborative business process instantiated in d);
f3) said second player and said third player taking roles selected from said roles assigned to said tasks in said second collaborative business process, wherein said tasks in said second collaborative business process are assigned to at least one said player in said second collaborative business process; and
f4) said second player and said third player executing said tasks in said second collaborative business process that are assigned to them based on their said taken roles, wherein said collaborative business process and said second collaborative business process are executed in a chain.

8. The method of claim 1, wherein f) comprises a first player storing data at its said node, said data associated with said taken role of said first player.

9. The method of claim 1, wherein f) comprises a first player storing data at its said node, said data associated with all said roles of said plurality of roles in b).

10. The method of claim 1, wherein f) comprises a first player storing data at its said node, said data associated with a subset of said roles of said plurality of roles in b).

11. A method of executing a collaborative business process, said method comprising:
a) instantiating said collaborative business process at a node for a first player of said collaborative business process, said collaborative business process comprising a plurality of tasks and a plurality of roles, said roles assigned to said tasks;
b) instantiating said collaborative business process at a node for a second player of said collaborative business process;
c) said first player and said second player taking one of said roles in said collaborative business process, wherein said tasks are assigned to at least one of said players; and
d) said first player and said second player executing said tasks that are assigned to them based on their said taken roles, wherein said collaborative business process is executed by said players.

12. The method of claim 11, wherein:
b) comprises instantiating said collaborative business process at a plurality of nodes for a corresponding plurality of players;
c) comprises said instantiating players selecting a role in said collaborative business process, wherein said tasks are assigned to at least one said instantiating player; and
d) comprises said instantiating players executing said tasks that are assigned to them based on their said taken roles, wherein said collaborative business process is executed by said instantiating players.

13. The method of claim 11, further comprising:
e) said first player sending a message to said second player indicating that said first player has finished execution of one of its said assigned tasks.

14. The method of claim 13, further comprising:
f) said second player responding to said message by determining that it is to execute one of its said assigned tasks.

15. The method of claim 11, further comprising:
e) said first player sending a document to said second player, said document based on business objects.

16. The method of claim 11, further comprising:
e) said first player sending a document to said second player, said document based on business objects from the Common Business Library (CBL).

17. The method of claim 11, further comprising said first player sending a key to said second player, said key identifying the collaborative business process to instantiate at said node for said second player.

18. The method of claim 11, further comprising:
e) instantiating a second collaborative business process at said node for said second player of said collaborative business process, said second collaborative business process comprising a plurality of tasks and a plurality of roles, at least one of said roles assigned to at least one of said tasks;
f) instantiating said second collaborative business process at a node for a third player;
g) said second player and said third player taking roles in said second collaborative business process, wherein said second player and said third player are assigned tasks to execute in said second collaborative business process; and
h) said second and said third players executing said tasks that are assigned to them based on their said taken roles.

19. The method of claim 11, wherein d) comprises said first player storing data at its said node, said data associated with said taken role of said first player, wherein said first player modifies and has access to said data.

20. The method of claim 11, wherein d) comprises said first player storing data at its said node, said data associated with said roles of said plurality of roles in a), wherein said data is common to said first player and said second player.

21. The method of claim 11, wherein c) comprises said first player sending a message to bind said first player to said role taken by said first player.

22. The method of claim 11, wherein d) comprises said first player executing one of its said assigned tasks by executing a sub-process at its said node.

23. A computer-readable medium having stored thereon instructions which, when run on a processor, execute a method of executing a portion of a collaborative business process, said method comprising:
a) instantiating said collaborative business process at a first node, said collaborative business process comprising a plurality of tasks and a plurality of roles, said tasks having at least one of said roles of said plurality assigned to them;
b) selecting, at said first node, a role of said plurality to play in said collaborative business process, wherein at least one of said tasks in said collaborative business process is assigned to be performed at said first node; and
c) executing said assigned at least one of said tasks when it is the turn of said first node to execute, based on said selected role, wherein said tasks in said collaborative business process that are assigned to said first node are executed at said first node.

24. The computer-readable medium of claim 23, wherein said method further comprises:
d) sending a message to a second node indicating that said first node has finished execution of one of its assigned tasks, wherein said first node and said second node execute said collaborative business process in synchronized fashion.

25. The computer-readable medium of claim 23, wherein said method further comprises:
d) receiving a message from a second node indicating that said second node has finished execution of one of its assigned tasks, wherein said first node and said second node execute said collaborative business process in synchronized fashion.

26. The computer-readable medium of claim 23, wherein said method further comprises:
d) sending a document to a second node, said document based on business objects.

27. The computer-readable medium of claim 23, wherein said method further comprises sending an identifier to a second node, said identifier identifying the collaborative business process instantiated at said first node.

28. The computer-readable medium of claim 23, wherein said method further comprises:
d) instantiating a second collaborative business process at said first node, said second collaborative business process comprising a plurality of tasks and a plurality of roles, each task having a role assigned to it;
e) taking a role in said second collaborative business process, wherein at least one task in said second collaborative business process is assigned to be performed by said first node; and
f) executing said assigned tasks in said second collaborative business process based on its said taken role, when it is the turn of said first node to execute a task in said second collaborative business process, wherein said collaborative business process and said second collaborative business process are executed in a chain.

29. The method of claim 23, wherein b) comprises said first node sending a message to bind said first node to said role.

30. A computer-readable medium having stored therein a structure for a protocol for implementing a collaborative business process to be executed by a plurality of players, said protocol comprising:
a structure for specifying a plurality of roles to be played in said collaborative business process, said roles to be selected by the players to execute said collaborative business process;
said structure further specifying a plurality of tasks to be performed in said collaborative business process, said tasks associated with one of said roles, wherein said tasks are to be executed by said players selecting the role associated with said tasks when said protocol is executed; and
said structure further specifying the sequence in which said tasks are to be executed.

31. The computer-readable medium of claim 30, wherein said protocol further comprises a second structure for dynamically specifying the role a first player is to take in said collaborative business process, said second structure to be sent by said first player to bind said first player to said role when said collaborative business process is being executed.

32. The computer-readable medium of claim 30, wherein said structure is substantially compliant with the Extensible Markup Language (XML).

33. The computer-readable medium of claim 30, wherein said structure further comprises a data container.

34. The computer-readable medium of claim 33, wherein said data container is assigned to one of said roles, wherein said data is private.

35. The computer-readable medium of claim 33, wherein said data container is assigned to a plurality of said roles, wherein said data is public.

36. The computer-readable medium of claim 33, wherein said data container is assigned to a subset of all of the roles in said collaborative business process, wherein said data is semi-public.

37. The computer-readable medium of claim 30, wherein said structure further comprises:
a plurality of route nodes for specifying which said task to execute upon a specified condition; and
wherein said structure specifying the sequence in which said tasks are to be executed further specifies the sequence said tasks and said route nodes are to be executed.

38. The computer-readable medium of claim 30, wherein said protocol further comprises a structure for specifying the types of documents allowed.

39. The computer-readable medium of claim 38, wherein said documents are based on common business objects.

40. The computer-readable medium of claim 38, wherein said documents are based on the Common Business Library (CBL).

41. The computer-readable medium of claim 38, wherein said structure for specifying the types of documents allowed further specifies the rules for document exchange.

42. The computer-readable medium of claim 41, wherein at least one of said tasks has associated therewith one of said documents.

43. A method of defining a collaborative business process, said method comprising:
a) designing said collaborative business process to be executed by a plurality of enterprises, said collaborative business process comprising a plurality of tasks;
b) assigning a plurality of roles to said collaborative business process, said roles to be selected by said enterprises; and
c) assigning one of said roles to each of said plurality of said tasks, wherein said tasks are to be executed by said enterprise that selects the role assigned to said task.

44. The method of claim 43, further comprising:
d) assigning a document to be transferred as a part of executing one of said tasks; and
e) relating said collaborative business process to at least one business object by basing said document on business objects in a library of standard defined business objects.

45. The method of claim 43, further comprising:
d) chaining together a plurality of said collaborative business processes.

46. The method of claim 43, further comprising:
d) defining one of said tasks in said collaborative business process from a) to be executed with a second collaborative business process.

47. The method of claim 43, further comprising:
d) designing a second collaborative business process;
e) incorporating said second collaborative business process into said collaborative business process designed in a) as a task to be executed in said collaborative business process designed in a); and
f) assigning at least one role to said second collaborative business process that was not assigned in said collaborative business process designed in a), wherein said second business process is operable to be executed by an enterprise that is not involved with said collaborative business process designed in a).
